(19) United States
(12) Patent Application Publication
(10) Pub. No.: US 2026/0005282 A1
(43) Pub. Date: Jan. 1, 2026

(54) METHOD AND DEVICE FOR LAMINATING COMPONENTS OF A BATTERY CELL

(71) Applicant: Volkswagen Aktiengesellschaft, Wolfsburg (DE)

(72) Inventors: Adrian BECKER, Bockenem (DE); Christian KLEMT, Meine (DE); Tobias JANSEN, Braunschweig (DE); Marco JORDAN, Salzgitter (DE); Kristian LIPPKY, Braunscheig (DE)

(73) Assignee: Volkswagen Aktiengesellschaft, Wolfsburg (DE)

(21) Appl. No.: 18/649,958

(22) Filed: Apr. 29, 2024

Related U.S. Application Data
(63) Continuation of application No. PCT/EP2022/079801, filed on Oct. 25, 2022.

(30) Foreign Application Priority Data
Oct. 29, 2021 (DE) 10 2021 128 348.5

(51) Int. Cl. H01M 10/04

(52) U.S. Cl. CPC H01M 10/0404; H01M 10/0413

(57) ABSTRACT

A method for laminating components of a battery cell is provided. The components comprising at least one electrode of a first electrode type and a separator layer, which are arranged on top of one another along a stacking direction and form a stack. In addition, an apparatus for laminating components of a battery cell is disclosed.

This nonprovisional application is a continuation of International Application No. PCT/EP2022/079801, which was filed on Oct. 25, 2022, and which claims priority to German Patent Application No. 10 2021 128 348.5, which was filed in Germany on Oct. 29, 2021, and which are both herein incorporated by reference.

### BACKGROUND OF THE INVENTION

### Field of the Invention

The invention relates to a method and an apparatus for laminating components of a battery cell.

### Description of the Background Art

A battery cell comprises at least one electrode of a first electrode type and at least one electrode of a second electrode type, which are arranged stacked on top of each other along a stacking direction, separated from each other by a separator material. Electrodes and separators are referred to here as the components and form a stack as stacked layers. Each electrode has a carrier material coated with an active material and an arrester for making electrical contact with the electrode. The battery cell is in particular a secondary battery cell.

Batteries, in particular lithium-ion batteries, are increasingly being used to power motor vehicles. Batteries are usually composed of battery cells, with each battery cell having a stack of layers, namely anodes, cathodes (electrodes) and separator material in between. The arrester of each electrode is used to conduct the current provided by the battery cell to a consumer located outside the battery cell.

A battery cell regularly comprises a housing in which one or more stacks are arranged. The arresters of the electrodes of the same electrode type are connected in parallel within the housing and connected to a terminal on the housing. In a solid-state battery cell, a solid or non-liquid electrolyte is used. In other battery cells, the volume enclosed by the housing is filled with a liquid electrolyte. Both types of battery cells can be produced using the proposed process.

In particular, lamination involves heating the separator layers or separator materials so that they form an adhesive bond with the adjacent active material of the electrode.

Laminating an entire battery cell stack is a time-critical process in the production of lithium-ion battery cells. It is known to use so-called heat press machines for laminating stacks. In such machines, pressure and heat are applied to the stack by two heatable plates. The stack is heated by conduction. Beside lamination, stacks are fixed from the outside using tapes.

With the methods known to date, processing times of 45 to 60 seconds per stack must be taken into account. It is not possible to speed up the process. The reason for the long process time is the heat transfer by conduction, starting from each panel.

Compared to stacks fixed only by tapes, however, laminated stacks offer advantages in terms of handling and further processing into complete battery cells. Battery cells with laminated stacks have better qualitative properties, particularly in terms of longevity.

In a battery cell, gases produced by a variety of mechanisms can have negative effects on cell performance and characteristics. With lamination, the negative effects of evolved gases can be reduced by forcing the gas to the edges of the stack rather than allowing the gas to form bubbles between the individual layers of the stack, thereby increasing the interfacial resistance between the layers. Additionally, a laminated interface will often have a lower impedance (resistance) than one that is not laminated.

As a result of the adhesive bonding of the individual layers to each other, it can be ensured that the arrangement of the electrodes to each other (e.g. the alignment of the active materials along the stack direction) is maintained during the handling of the stack.

KR 2016 0047690 A discloses a device and a method for laminating battery cells using induction. Mono cells or bi-cells are fed through the device as continuous material. Lamination therefore takes place on cell components moved through the device.

JP 2004-207178 A discloses a device and a method for manufacturing a fuel cell or a battery cell, whereby an electrode is connected to a housing. An adhesive is used which is inductively heated.

EP 3 147 983 A1, which corresponds to US 2017/0069928, discloses a method and a device for manufacturing a fuel cell. Electrodes and separators are arranged on top of each other to form a stack and bonded together using adhesive. The stack is heated inductively.

### SUMMARY OF THE INVENTION

It is therefore an object of the present invention is to solve at least in part the problems cited with reference to the prior art. In particular, a method and an apparatus are provided via which it is possible to laminate the components of a battery cell. The battery cell should be able to be produced as cost-effectively as possible, with the layers of a stack of components being arranged as precisely as possible on top of each other and remaining in place during the handling of the stack.

A method for laminating components of a battery cell is proposed. The components comprise at least one electrode of a first electrode type and a separator layer, which are arranged on top of each other along a stacking direction and form a stack. The method comprises at least the following steps: (a) providing an apparatus for laminating by induction, having at least a first plate and a second plate and an induction device; (b) arranging the stack of components between the first plate and the second plate; (c) pressing the stack through the plates along the stacking direction; (d) operating the induction device and heating the at least one separator layer to form an adhesive bond between the separator layer and the electrode; (e) moving the plates apart; and (f) removing the laminated components from the apparatus.

The above (non-exhaustive) classification of the process steps into a) and f) is intended primarily only for differentiation and is not intended to enforce any sequence and/or dependency. The frequency of the process steps can also vary. It is also possible for process steps to at least partially overlap or to be carried out simultaneously. Steps a) to c) and then e) and f) are preferably carried out after one another. Steps c) and d) can be carried out one after the other, interchanged or at least temporarily simultaneously. In particular, steps a) and b) as well as e) and f) are carried out in the specified order, with steps c) and d) being carried out in any order or at least partially together between steps b) and e). If necessary, at least step d) can be carried out at least partially during step e).

The apparatus provided in step a) comprises in particular a first plate and a second plate with which the stack can be pressed. The plates are designed in particular such that the mutually contacting surfaces (hereinafter also referred to as contact surfaces) of the stack and plates are each arranged or extend parallel to one another. In particular, the corresponding surfaces of the plates extend at least beyond the surfaces of the stack contacting these plates, if necessary, and are therefore larger in terms of surface area. In particular, the stack can be pressed together via the plates, in particular with a force distribution that is as homogeneous as possible, at least in planes that each extend parallel to the contact surfaces.

At least one plate can have a nanoscale or macroscale structure on one surface of the contact area so that adhesion between the plate and the stack can be prevented. Alternatively or additionally, holes can be provided in the plate through which, for example, compressed air or a mechanical ejector can be fed to separate the plate and stack.

In particular, several stacks can also be arranged between the plates in step b) and processed further.

In particular, the induction device can comprise one or more induction coils, via which at least parts of the stack can be heated directly. During operation of the induction device, eddy currents are generated in the electrically conductive component, thereby heating it directly. Heating by induction is more efficient than other heating methods because the energy is induced directly into the component intended for heating, i.e. the heat is generated directly in the respective component and does not have to be transferred from the outside to the inside of the stack/components by heat conduction, radiation or convection, as is the case with other heating methods.

When laminating the components, inductive heating is particularly advantageous because even in the case of larger stacks with a large number of components, all components (or those intended for heating) can be heated, including the components that are arranged at a distance from the respective inductor.

In step b), the stack is arranged between the plates. The stack can already be provided outside the apparatus and then arranged as a stack in the apparatus. Alternatively, the stack can also be formed in the apparatus by the components.

In step c), the stack is pressed through the plates. The components of the stack are pressed together, in particular at a pressure of more than one bar, preferably at a pressure of more than 2 bar. In particular, pressing takes place at a pressure of at most 20 bar, especially at most 10 bar. As a result of the pressing, air is pressed out of the stack in particular, so that the components of the stack form contact surfaces with each other that are as large as possible. In particular, a basically known force-displacement control is used during pressing in order to control the pressure in a targeted manner during pressing.

In step d), the induction device is operated and the at least one separator layer is heated to form an adhesive bond between the separator layer and the electrode. In particular, the separator layer is not heated directly. In particular, another component of the stack (i.e. not the separator layer) is heated via induction. The separator layer is then heated in particular by heat conduction from the component heated by induction. Alternatively or additionally, the separator layer can also be heated.

In step e), the plates are moved apart, i.e. the pressing of the stack is completed. In particular, the separation takes place only after the components have cooled to a temperature below a melting temperature (or a glass transition temperature) of at least one of the components. This prevents the formation of bubbles in particular.

In step f), the laminated components and/or the laminated stack are removed from the apparatus. In particular, all components of the stack are bonded together at least by the adhesion generated by the process.

In particular, the stack can have a plurality of electrodes of the first electrode type (e.g. an anode or cathode) and a plurality of electrodes of a second electrode type (different from the first electrode type) (e.g. a cathode or anode) as well as a separator layer between each of the electrodes.

In particular, the stack can have at least ten electrodes of one type of electrode, preferably at least 100 electrodes of one type of electrode, particularly preferably at least 200 electrodes of one type of electrode.

In the conventional art, a large number of components cannot be produced in a continuous process. The method proposed here, in which individual electrode layers are already arranged to form the stack and the stack with the components is already trimmed ready for arrangement in the battery cell after lamination, makes it possible to laminate a large number of stacked components.

Separator layers and electrodes can be stacked on top of each other to form the stack, whereby the different separator layers are not connected to each other.

In particular, at least some of the separator layers are connected to each other. For example, two separator layers each form a pocket for an electrode, so that this is arranged in the closed pocket. Alternatively, a one-piece separator layer can extend across several electrodes in the manner of a Z-fold. In particular, a one-piece separator layer in the form of a Z-fold extends over all the electrodes in the stack.

In particular, all separator layers are connected to one another and the stack may have only one separator material made in one piece.

In particular, the at least one or exactly one separator layer can extend around the stack and is thus arranged in steps b) to e) between the stack and the first plate and between the stack and the second plate. This allows the stack as a whole to be surrounded by the separator layer and the components to be fixed in their relative arrangement to one another.

In particular, the at least one electrode has a carrier material and a coating with active material on at least one side surface of the carrier material. The coating can be arranged in the stack between the carrier material and the separator. In particular, the induction device is operated in such a way that the carrier material is heated via induction, whereby the carrier material heats the at least one separator layer by thermal conduction.

In particular, the separator material can be designed with particles or comprise a coating with particles, whereby the particles can be heated via induction.

In particular, the individual electrodes comprise a foil-like carrier material, e.g. made of a copper or aluminum material. The carrier material can be coated with an active material on one side or, in particular, on both sides. The active materials of different electrode types are separated from each other, in particular by the separator material.

In particular, the respective arrester can be formed by an uncoated area of the carrier material.

In particular, the induction device can be operated in such a way that particularly suitable parameters are selected with regard to the respective material of the carrier material. This allows efficient heating of the carrier material to be achieved.

In particular, at least one or possibly each plate can be designed as an inductor or has at least one inductor.

In particular, at least one of the plates has a plurality of inductors.

Alternatively, the at least one inductor can also be arranged at a distance from or arranged only separately from the plates.

In particular, it is proposed to arrange a stack of individual electrodes and separator layers between two plates. In particular, inductors are arranged integrated in the plates. A defined force can be applied to the stack through the plates. In particular, the inductors enable material-specific heating of the electrodes from the inside, as material-dependent frequency control can be enabled. The temperature required for lamination can thus be reached in the entire stack within a few seconds.

In particular, lamination of a stack can be achieved in less than 20 seconds, especially less than 15 seconds or even less than 10 seconds. In particular, this time is independent of the number of layers within the stack. In particular, a stack comprising at least 100 electrodes of one type of electrode, especially preferably at least 200 electrodes of one type of electrode, can therefore also be (completely) laminated within the specified time of at most 20 seconds.

The method achieves a more homogeneous heating (in particular taking into account the short duration of the heating) of the stack or the components, in particular compared to heating via convection or conduction. This is achieved in particular by the targeted heating of the carrier materials distributed in the stack, via which the respective separator materials are then heated.

Furthermore, the porous structure of the separator material can be maintained as a result of the heating of the electrodes and the heating of the separators. It is not the separator material as a whole that is heated, but in particular only the contact surface of the separator material to the adjacent electrode.

An apparatus for laminating components of a battery cell is also proposed. The apparatus is suitably designed or set up or equipped for carrying out at least steps b) to e) of the method described, and comprises at least a first plate, a second plate and an induction device.

In particular, the apparatus has a control unit which is set up, equipped, configured or programmed to carry out the described method or at least steps b) to e).

The control unit can be used at least for: operating and/or controling the apparatus for laminating, e.g. operating the induction device; or moving the plates towards each other (for pressing the stack) and/or away from each other, in particular in a path and force-controlled manner; or controlling the handling of the stack or individual components.

A battery cell is also proposed, the battery cell comprising a housing enclosing a volume and, arranged in the volume, the at least one stack and an electrolyte.

The battery cell can be a pouch cell (with a deformable housing formed of a pouch foil) or a prismatic cell (with a dimensionally stable housing). A pouch foil is a known deformable housing part that is used as a housing for so-called pouch cells. It is a composite material, e.g. comprising a plastic and aluminum.

The battery cell can be a lithium-ion battery cell.

The individual electrodes are arranged on top of each other and form the stack. The electrodes are each assigned to different electrode types, i.e. they are designed as an anode or a cathode. The anodes and cathodes are arranged alternately and separated from each other by the separator material.

A battery cell is a power storage device that is used, for example, in a motor vehicle to store electrical energy. In particular, for example, a motor vehicle has an electrical machine for driving the motor vehicle (a traction drive), whereby the electrical machine can be driven by the electrical energy stored in the battery cell.

A motor vehicle is further proposed, at least comprising a traction drive and a battery with at least one of the battery cells described, wherein the traction drive can be supplied with energy by the at least one battery cell.

The method can be carried out by or with the cooperation of a computer or with a processor of a control unit.

Accordingly, there is also proposed a system for processing data comprising a processor adapted/configured to perform the method or part of the steps of the proposed method.

A computer-readable storage medium may be provided, comprising instructions which, when executed by a computer/processor, cause the computer/processor to perform the method or at least part of the steps of the proposed method.

The explanations relating to the battery cell method are in particular transferable to the apparatus for laminating, the battery cell, the motor vehicle, the control unit and the computer-implemented method (i.e. the computer or processor, the system for data processing, the computer-readable storage medium) and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an apparatus for laminating with a stack in a side view;

FIG. 2 shows a section of the apparatus with the stack according to FIG. 1 in a side view;

FIG. 3 shows a stack formed from n-monocells, in a side view;

FIG. 4 shows a stack with a one-piece separator material, in a side view;

FIG. 5 shows a side view of a carrier material coated on one side with an active material, e.g. an anode;

FIG. 6 shows a side view of a carrier material coated on both sides with an active material, e.g. a cathode;

FIG. 7 shows a side view of a mono cell comprising an anode coated on one side and a cathode coated on one side, the cathode being arranged in a separator material pocket;

FIG. 8 shows a stack with separator material folded in a Z-shape, in a side view;

FIG. 9 shows a stack with stacked monocells, with the anodes each arranged in a separator material pocket, in a side view;

FIG. 10 shows a plate designed as an inductor in a side view and a top view; and

FIG. 11 shows a plate with a plurality of inductors in a side view and a top view.

### DETAILED DESCRIPTION

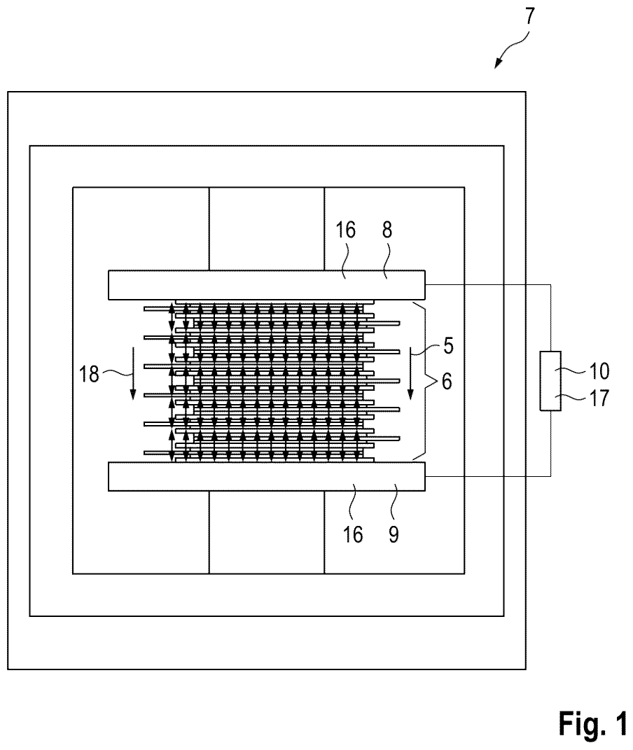

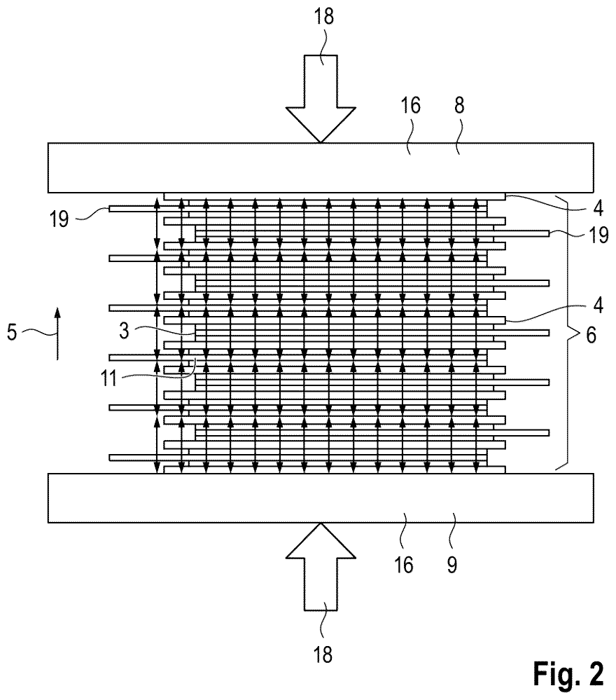

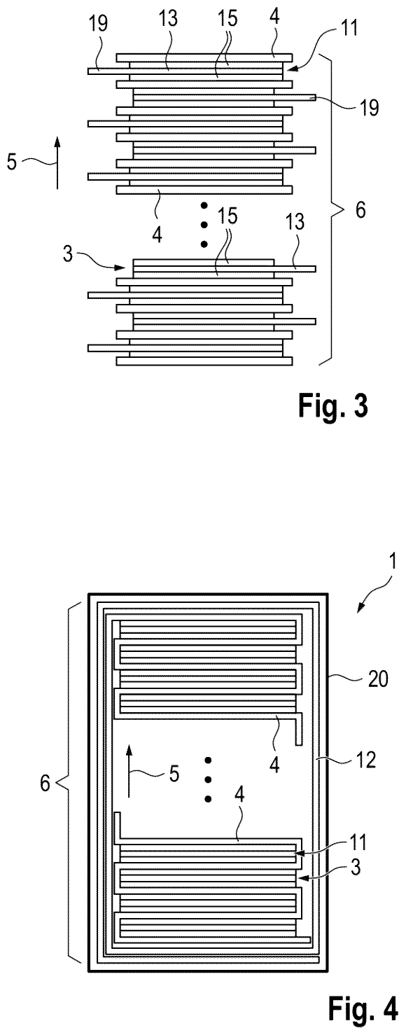

FIG. 1 shows an apparatus 7 for laminating with a stack 6 in a side view. FIG. 2 shows a section of the apparatus 7 with the stack 6 according to FIG. 1 in a side view. FIG. 3 shows a stack 6 formed from n-monocells in a side view. FIGS. 1 to 3 are described together below.

The apparatus 7 is suitably designed or set up or equipped for carrying out at least steps b) to e) of the method described, and comprises a first plate 8, a second plate 9 and an induction device 10. Furthermore, the apparatus 7 has a control unit 17. The control unit 17 can be used to operate or control the apparatus 7 for laminating, for example to operate and control the induction device 10 and to move the plates 8, 9 towards each other (for pressing the stack 6) and/or away from each other, in particular to control the path and force. The force can be measured by the control unit in order to ensure damage-free pressing of the stack.

According to step a) of the method, an apparatus 7 for laminating via induction is provided, comprising a first plate 8 and a second plate 9 and an induction device 10. According to step b), the stack 6 of components is arranged between the first plate 8 and the second plate 9. The components comprise electrodes 2 of a first electrode type 3, electrodes 2 of a second electrode type 11 and a separator layer 4, which are arranged on top of one another along a stacking direction 5 and form a stack 6. In step c) of the method, the stack 6 is pressed by the plates 8, 9 along the stacking direction 5 with the force 18 (see FIGS. 1 and 2). In step d), the induction device 10 is operated and the separator layers 4 are heated to form an adhesive bond between each separator layer 4 and the electrode 2 arranged adjacent thereto. In FIG. 2, the heat conduction within the stack 6 is shown starting from each carrier material 13 of each electrode 2. In step e) the plates 8, 9 are moved apart and in step f) the laminated components are removed from the apparatus 7.

The plates 8, 9 of the apparatus 7 are designed in such a way that the contacting surfaces (hereinafter also referred to as contact surfaces) of stack 6 and plates 8, 9 are arranged or run parallel to each other. The corresponding surfaces of the plates 8, 9 extend beyond the surfaces of the stack 6 contacting these plates 8, 9, i.e. they are larger in area. The stack 6 can be pressed together via the plates 8, 9, whereby a force distribution that is as homogeneous as possible should be achieved, at least in planes that extend parallel to the contact surfaces.

The induction device 10 comprises one or more inductors 16 or induction coils, via which at least parts of the stack 6 can be heated directly.

In step d), the induction device 10 is operated and the separator layer 4 is heated to form an adhesive bond between the separator layer 4 and the electrode 2. The separator layer 4 is not heated directly. Another component of the stack 6, namely the carrier materials 13 of the electrodes 2 (i.e. not the separator layer 4), is heated by induction. The separator layer 4 is then heated by heat conduction from the component heated by induction.

The stack 6 has a plurality of electrodes 2 of the first electrode type 3 (e.g. an anode or cathode) and a plurality of electrodes 2 of a second electrode type 4 (e.g. a cathode or anode) (different from the first electrode type 3) as well as a separator layer 4 between each of the electrodes 2.

The individual electrodes 2 have a foil-like carrier material 13, e.g. made of a copper or aluminum material. The carrier material 13 is coated on both sides with an active material. The active materials of different electrode types 3, 11 are separated from each other by the separator material 12. The respective arrester 19 of an electrode 2 is formed by an uncoated area of the carrier material 13.

FIG. 4 shows a stack 6 with a one-piece separator material 12 in a side view. Reference is made to the explanations in FIGS. 1 to 3.

A one-piece separator layer 4 extends across all electrodes 2 of the stack 6 in the manner of a Z-fold. All separator layers 4 are connected to each other and the stack 6 has only one separator material 12 in one piece.

The exactly one separator layer 4 extends around the stack 6 and is thus arranged in steps b) to e) between the stack 6 and the first plate 8 and between the stack 6 and the second plate 9. This allows the stack 6 to be surrounded by the separator layer 4 as a whole and the components to be fixed in their relative arrangement to one another.

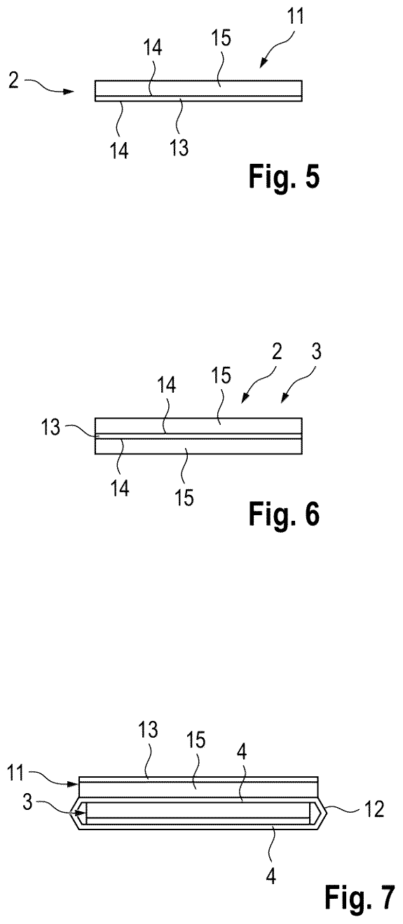

FIG. 5 shows a carrier material 13 coated on one side with an active material, e.g. an anode, in a side view. The electrode 2 has a carrier material 13 and a coating 15 with active material on one side surface 14 of the carrier material 13.

FIG. 6 shows a side view of a carrier material 13, e.g. a cathode, coated on both sides with an active material. Reference is made to the explanations in FIG. 5.

FIG. 7 shows a side view of a mono cell comprising an anode coated on one side and a cathode coated on one side, the cathode being arranged in a separator material 12 designed as a pocket. The respective electrode 2 has a carrier material 13 and a coating 15 with active material on one side surface 14 of the carrier material 13.

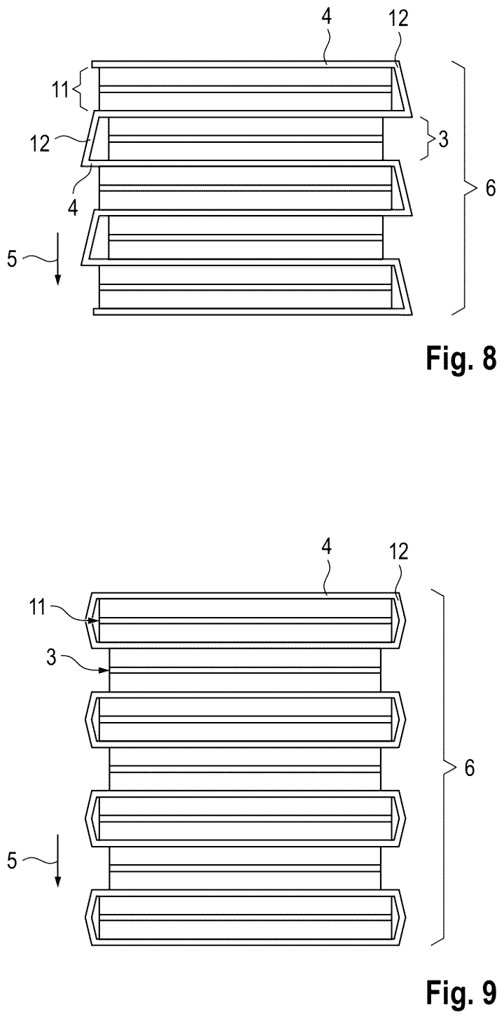

FIG. 8 shows a stack 6 with separator material 12 folded in a Z-shape, in a side view. Reference is made to the explanations on FIG. 4. The respective electrode 2 has a carrier material 13 and a coating 15 with active material on both side surfaces 14 of the carrier material 13.

FIG. 9 shows a stack 6 with stacked mono cells, whereby the anodes are each arranged in a pocket of separator material 12, in a side view. The respective electrode 2 has a carrier material 13 and a coating 15 with active material on both side surfaces 14 of the carrier material 13.

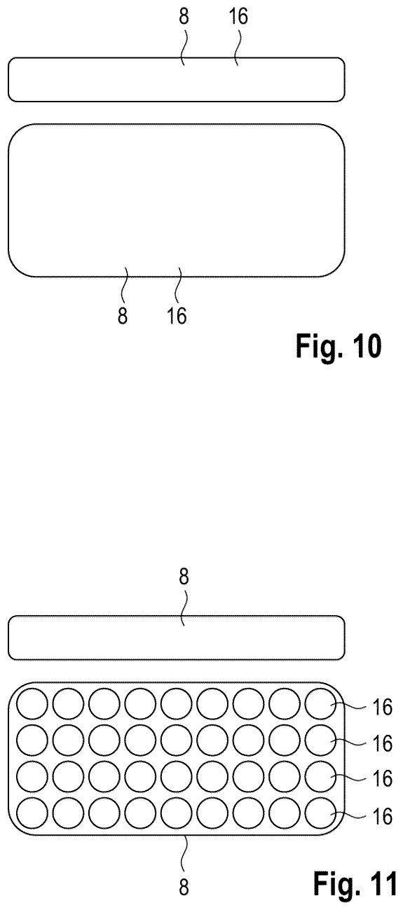

FIG. 10 shows a plate 8 designed as an inductor 16 in a side view and a top view. Reference is made to the explanations in FIGS. 1 to 3.

FIG. 11 shows a plate 8 with a plurality of inductors 16 in a side view and a top view. The individual inductors 16 can be operated via a control unit 17, e.g. individually, so that the heat input can be controlled via induction depending on the location.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for laminating components of a battery cell, the components comprising at least one electrode of a first electrode type and a separator layer that are arranged on top of each other along a stacking direction and form a stack, the method comprising:
providing an apparatus to laminate by induction, the apparatus having at least a first plate and a second plate and an induction device;
arranging the stack of components between the first plate and the second plate;
pressing the stack through the plates along a stacking direction;
operating the induction device and heating the at least one separator layer to form an adhesive bond between the separator layer and the electrode;
moving the plates apart; and
removing the laminated components from the apparatus.

2. The method according to claim 1, wherein the stack comprises a plurality of electrodes of a first electrode type and a plurality of electrodes of a second electrode type and a separator layer arranged between each of the electrodes.

3. The method according to claim 1, wherein the stack comprises at least ten electrodes of one electrode type.

4. The method according to claim 2, wherein at least a portion of the separator layers are connected to one another.

5. The method according to claim 4, wherein all separator layers are interconnected and the stack comprises only one separator material made in one piece.

6. The method according to claim 1, wherein the at least one separator layer extends around the stack and is arranged between the stack and the first plate and between the stack and the second plate.

7. The method according to claim 1, wherein the at least one electrode comprises a carrier material and a coating with active material on at least one side surface of the carrier material, wherein the coating is arranged in the stack between the carrier material and the separator, wherein the induction device is operated such that the carrier material is heated via induction, and wherein the carrier material heats the at least one separator layer by heat conduction.

8. The method according to claim 1, wherein each plate is designed as an inductor or comprises at least one inductor.

9. The method according to claim 1, wherein at least one of the plates comprises a plurality of inductors.

10. An apparatus to laminate components of a battery cell, wherein the apparatus is adapted to carry out the method according to claim 1, and comprises at least a first plate, a second plate and an induction device.
